(19) United States
(12) Patent Application Publication
(10) Pub. No.: US 2019/0130717 A1
(43) Pub. Date: May 2, 2019

(54) Smoke Alarm Mounting and Dismounting System and Method

(71) Applicant: Holy Smoke Alarms Pty Ltd., Merrylands (AU)

(72) Inventor: Darin Vincent Leatherby, Merrylands (AU)

(21) Appl. No.: 15/714,581

(22) Filed: Sep. 25, 2017

Related U.S. Application Data
(63) Continuation-in-part of application No. 14/911,269, filed on Feb. 10, 2016, now Pat. No. 9,805,571.

(51) Int. Cl. G08B 17/113

(52) U.S. Cl. CPC G08B 17/113

(57) ABSTRACT

In a first aspect there is disclosed an adapter (100) for use in mounting and/or dismounting a gaseous substance detector (102) from an overhead surface. The adapter (100) comprises a detector abutment (104) for operative placement adjacent an outer surface (107) of the detector (100). The detector abutment (104) defines an opening (106). The adapter (100) further includes a coupling (108) operatively associated with the detector abutment (104). The coupling (108) is operatively adapted for releasable attachment to an elongate implement (110) to provide fluid communication between the opening (106) in the detector abutment (104) and the elongate implement (110). In use a low air pressure force in the elongate implement (110) is applied to the detector (102) via the opening (106) to secure the detector (102) to the adapter (100).

### FIELD

The present invention generally relates to arrangements for accessing detectors, in particular but not exclusively smoke alarms or detectors for detecting the presence of gaseous substances, mounted to an overhead surface. The invention extends to methods for retaining and releasing detectors, such as smoke alarms, from a supporting element, including a vacuum operated locking device for connecting a smoke alarm to the supporting element.

### BACKGROUND

Locking devices are known devices for securing components to one another. The most, common use is retaining doors in a closed position, however, many other examples exist including securing components of an assembly together. The present invention particularly relates to locking devices used in smoke alarms, either for retaining a protective cover or for retaining the smoke alarm itself to a ceiling, wall, or other mounting point, as well as methods for mounting and demounting a smoke alarm.

Smoke alarms require periodic access, such as for replacing batteries or for cleaning. As they are generally mounted on ceilings, gaining access can be difficult, particularly in older style homes where ceilings may be very high. This poses a safety risk as inexperienced people using ladders in their homes may fall. An alternative risk is that the smoke alarms will be neglected due to the difficulty of access, resulting in malfunction due to flat batteries not being replaced or dust obstructing required openings.

It is an object of the present invention to address or ameliorate some of the above disadvantages.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

The term “comprising” (and grammatical variations thereof) is used in this specification in the inclusive sense of “having” or “including”, and not in the exclusive sense of “consisting only of”.

The above discussion of the prior art is not an admission that, any information, discussed therein is citable prior art or part of the common general knowledge of persons skilled in the art in any country.

### SUMMARY

According to one example aspect, there is provided a locking device for releasably securing a first component to a second component, wherein the locking device can be moved to a released position by providing a region of low air pressure proximal to a first opening of the first component.

According to another example aspect, the first component further includes a second opening, wherein a conduit is configured to provide fluid communication between the first and second openings, and a pin is located at least partially inside the conduit.

According to another example aspect, the pin protrudes from the second opening when the pin is in an extended position and the locking device is in a locked position.

Preferably the pin is more substantially within the conduit when the pin is in a retracted position and the locking device is in a released position.

According to another example aspect, the second component includes a recess, wherein the pin is at least partially inside the recess when the locking device is in the locked position.

According to yet another optional aspect, the pin can be moved from the extended position to the retracted position by providing the region of low air pressure.

Preferably the pin can be moved from the retracted position to the extended position by gravity.

In accordance with other optional embodiments, provided by way of example only, the pin is biased towards the extended position by a biasing means.

In other particular, but non-limiting, example forms the biasing means includes one or more magnets or one or more springs.

Preferably an outside surface of the first device is configured so that the region of low air pressure can be provided by a vacuum cleaner.

In another particular, but non-limiting, example the first component includes one or more additional said locking devices.

Preferably the first component is a smoke alarm or detector for detecting a gaseous sub stance.

In another form the first and/or second component is a door.

According to yet another example aspect there is provided a method of releasably securing a first component to a second component using a locking device, the first component including a first opening, wherein the method of releasing the first component from the second component includes placing a vacuum cleaner proximal to the first opening.

In a further broad form there is provided a method of mounting and dismounting a smoke alarm from a supporting element mounted to an overhead surface, said method including the steps of:

inserting an elongate implement into an opening provided in a body of the smoke alarm,

applying a force via the elongate implement so as to detach the body of the smoke alarm from the supporting element, and

wherein the elongate implement is applied by a user standing on a floor surface below the overhead surface.

Preferably the force is a low air pressure force, the elongate implement being a wand or wand attachment of a vacuum cleaner.

Preferably the low air pressure force acts to release a retaining mechanism connecting the smoke alarm to the supporting element.

Preferably the retaining mechanism includes retractable pins extending from the body of the smoke alarm to engage with corresponding recesses in the supporting element, the pins being retracted into a non-engaging position when the low air pressure force is applied to the opening.

Preferably the low air pressure force secures the smoke alarm to an outer end of the wand or wand attachment sufficient to pull the smoke alarm free from a flexible annular retaining ring of the supporting element affixed to the overhead surface by applying a downward force to the wand.

Preferably an outer end of the wand or wand attachment is of rectangular cross section, the opening in the body of the smoke alarm being of similar rectangular cross section, the outer end of the wand or wand attachment being inserted into and engaging with the opening so as to release the smoke alarm from a bayonet type connection by sequentially applying a turning force and a downward force to the wand.

Preferably the force is a downward force, the elongate implement being a handle of a cleaning device provided at an outer end with a threaded stud, the threaded stud engaging with a corresponding thread of a socket accessed through the opening.

Preferably the force is a sideways force to disengage a magnetic plate at the upper surface of the smoke alarm from a magnetic plate comprising the retaining element.

Preferably the magnetic plate of the retaining element is adhesively secured to the overhead surface.

In another broad form of the invention there is provided a smoke alarm mounted to an overhead surface, the smoke alarm comprising a retaining element and a body portion, the body portion provided with an opening for insertion of the end of an elongate implement into the body portion.

Preferably the opening comprises a cylindrical socket.

Preferably the opening comprises a rectangular sectioned socket.

Preferably the opening comprises a threaded socket.

Preferably the elongate implement is a wand or wand attachment of a vacuum cleaner, a partial vacuum provided by the vacuum cleaner when the wand or viand attachment is inserted into the opening acting to change a retaining mechanism connecting the smoke alarm body to the retaining element from a retaining state to a released state.

Preferably the body portion includes at least one conduit in communication with the opening, a pin located in the conduit extending from the conduit to engage with the retaining element when the pin is in the extended state, the pin being retracted into a non-engaged state when low air pressure is applied to the opening.

Preferably the partial vacuum provides sufficient attachment of the wand or wand attachment to the body portion of the smoke alarm to allow dismounting of the body portion from the supporting element to bring the body portion within reach of a user standing on a floor surface below the mounted location of the smoke alarm.

Preferably the body of the smoke alarm is retained by the supporting element through a bayonet connection, rotation and downward movement of the wand of a vacuum cleaner fitted with a rectangular section wand attachment engaged with the rectangular sectioned socket disconnecting the body portion of the smoke alarm from the supporting element.

Preferably the elongate implement is a handle of cleaning or other household devices, the handle provided with a threaded stud at an outer end of the handle, the thread of the threaded stud conforming to the thread of the threaded socket.

Preferably the body portion of the smoke alarm is provided with an annular flexible ring, the supporting element provided with an outwardly projecting annular flange, the body of the smoke alarm supported by engagement between the annular flexible ring and the outwardly projecting annular flange.

Preferably the supporting element is provided with an inwardly projecting annular flexible ring, the body of the smoke alarm provided with a projecting annular flange, the body of the smoke alarm supported by engagement between the annular flexible ring and the outwardly projecting annular flange.

Preferably a downward force applied to the elongate implement when the threaded stud is engaged in the threaded socket, disengages the smoke alarm body from the supporting element.

Preferably the supporting element comprises a magnetic plate affixed to the overhead surface, an upper surface of the body portion of the smoke alarm provided with a magnetic plate conforming to the magnetic plate of the supporting element, the body portion of the smoke alarm supported from the supporting element by magnetic attraction.

Preferably the supporting element is affixed to the overhead surface by double sided adhesive tape.

According to a further aspect there is disclosed herein an adapter for use in mounting and/or dismounting a gaseous substance detector from an overhead surface, the adapter comprising:

a detector abutment for operative placement adjacent an outer surface of the detector, the detector abutment defining an opening; and

a coupling operatively associated with the detector abutment, the coupling operatively adapted for releasable attachment to an elongate implement to provide fluid communication between the opening in the detector abutment and the elongate implement,

wherein a low air pressure force in the elongate implement is operatively applied to the detector via the opening to secure the detector to the adapter.

Preferably the adapter comprises a detector receptacle operatively associated with the detector abutment, the detector abutment having an inner surface defining a hollow compartment to hold the detector.

Preferably the detector receptacle comprises a receptacle base and a peripheral flange outwardly extending from the receptacle base to define the hollow compartment.

Preferably the detector abutment extends from the receptacle base into the hollow compartment of the detector receptacle.

Preferably the detector receptacle includes a vent projection extending from the receptacle base into the hollow compartment, the vent projection operatively adapted to be located within a vent opening of the detector.

Preferably the coupling comprises a male coupling member and a corresponding female coupling member adapted for movement relative to the male coupling member.

Preferably the male coupling member outwardly extends from an outer surface of the receptacle base.

Preferably the male coupling member is adapted to receive a portion of the elongate implement.

Preferably the female coupling member houses a resilient gripping member.

Preferably the coupling is configured such that relative movement between the male coupling member and the female coupling member causes deformation of the resilient gripping member, such deformation causing the resilient gripping member to grip an outer surface of the elongate implement.

Preferably the male coupling member includes a first threaded portion and the female coupling member includes a complemental second threaded portion.

Preferably the female coupling member includes a knurled outer surface.

Preferably the resilient gripping member comprises a resilient grommet.

Preferably the coupling includes an annular pressure ring.

Preferably the resilient gripping member is located between the male coupling member and the pressure ring.

A method of mounting and/or dismounting a gaseous substance detector from an overhead surface, the method comprising the steps of:

providing an adapter as defined above;

attaching the coupling of the adapter to an elongate implement to provide fluid communication between the opening in the detector abutment and the elongate implement;

locating the detector abutment of the adapter adjacent an outer surface of the detector; and

applying a low air pressure force to the opening via the elongate implement, the low air pressure force acting to secure the detector to the adapter.

### BRIEF DESCRIPTION OF DRAWINGS

Embodiments of the present invention will now be described with reference to the accompanying drawings wherein:

FIG. 1 illustrates a cross-sectional diagram of a preferred embodiment of a smoke alarm according to the invention;

FIG. 2 illustrates a top view of a smoke alarm removed from a supporting bracket showing pins of a locking device according to an embodiment of the invention in an extended position;

FIG. 3 is a perspective view of the smoke alarm of FIGS. 1 and 2 locked to the supporting bracket;

FIG. 4 illustrates a bottom view of an embodiment in a locked position within a bracket;

FIGS. 5 and 6 are perspective and face views respectively of a further embodiment of a smoke alarm according to the invention;

FIGS. 7 and 8 are perspective and face views respectively of another preferred embodiment of a smoke alarm according to the invention;

FIG. 9 is a perspective view of another preferred embodiment of a smoke alarm and release system according to the invention;

FIG. 10 is a cross section view of the smoke alarm of FIG. 9;

FIG. 11 illustrates an alternative preferred form of supporting element in the form of a magnetic plate;

FIG. 12 is a schematic cross-sectional view of an embodiment adapter;

FIG. 13 is a schematic cross-sectional view of the adapter of FIG. 12 holding a gaseous substance detector and coupled to an elongate implement;

FIG. 14 is a perspective top view of the adapter of FIG. 12 with a female coupling member thereof removed;

FIG. 15 is a perspective bottom view of the adapter of FIG. 14; and

FIG. 16 is a perspective view of a second embodiment adapter;

FIG. 17 illustrates a cross-sectional diagram of a preferred embodiment of a smoke alarm according to the invention.

### DESCRIPTION OF EMBODIMENTS

The following modes, given by way of example only, are described in order to provide a more precise understanding of the subject matter of a preferred embodiment or embodiments.

In the figures, incorporated to illustrate features of example embodiments, like reference numerals are used to identify like parts throughout the figures,

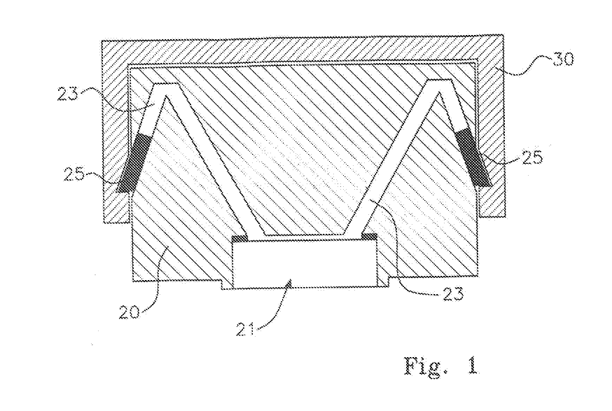

Referring to FIGS. 1A and 1B, cross-sectional diagrams of a preferred embodiment of a locking device 10 are shown for releasably securing a first component 20 to a second component 30. The first component 20 includes a first opening 21 and a second opening 22 that are connected by a conduit 23. The conduit 23 provides fluid communication between the first opening 21 and the second opening 22.

In the preferred embodiment the first component 20 is a smoke alarm and the second component 30 is a bracket. In other optional embodiments the first and second components 20, 30 may be any other components or objects that need to be releasably secured to each other. For example, the components may be cupboard doors being secured to one another, a cupboard door being secured to a door frame, a drawer being secured in a closed position, a fitting such as a light or decoration being secured to a ceiling or wall, or a storage device for securing or hanging items out of the way.

In the preferred embodiment a pin 25 is located at least partially inside the conduit 23 and protrudes from the second opening 22 when in an extended position as shown in FIG. 1A. The pin is in the extended position when the locking device 10 is in a locked position. The pin 25 can be retracted so that it is more substantially inside the conduit 23, this being a retracted position of the pin as shown in FIG. 1B and may be referred to as a released position of the locking device 10. In the retracted position the pin 25 may be entirely within the conduit 23, or may still protrude slightly from the second opening 22, but to a lesser extent than when in the extended position.

The second component 30 includes a recess 31. When the locking device 10 is in the locked position the pin 25 is partially inside the recess 31, as best seen in FIG. 1B, thereby preventing the first component 20 being removed from the second component 30. By moving the pin 25 to the retracted position, further into the conduit 23 as is the case in the released position, the pin 25 is removed from the recess 31. This allows the first component 20 to be removed from the second component 30.

The pin 25 can be moved into the retracted position by providing a region of low air pressure 41 at the first opening 21. Preferably, this region of low air pressure 41 is provided via a vacuum cleaner wand 40 inserted into the opening 21. The first opening 21 and the second opening 22 are in fluid communication, thereby transferring the low air pressure to an end of the pin 25, since it is located in the second opening 22. The low air pressure moves the pin 25 into the conduit 23, into the retracted position, so that, the locking device 10 is now in the released position.

When the region of low air pressure 41 is removed, such as by turning off the vacuum, cleaner 40, the pin 25 falls back into the extended position due to the force of gravity. If the first component 20 and second component 30 are in the appropriate positions relative to one another at this time this results in the locking device 10 being in the locked position.

In alternative embodiments, a biasing means may be included to bias the pin 25 towards the extended position. This would allow different arrangements of the locking device 10 where gravity does not cause the pin 25 to move to the extended position, such as a horizontally facing pin 25. Similarly, it would allow the first component 20 to be mounted at any angle, such as a smoke alarm being mounted to a wall rather than a ceiling. The biasing means could include, but is not limited to, magnets, coil springs, resilient material, or any other suitable spring.

The biasing means is particularly important if the locking device 10 is being used to retain cupboard doors. The orientation required in such a situation will often mean it is not possible to arrange the locking device 10 so that the pin 25 will return to the extended position under the force of gravity alone.

The operation of the locking device 10 may be improved by limiting the air flow past the pin 25. This can be accomplished by for example, but not limited to, providing a bushing, gasket, washer, O-ring or other sealing mechanism between the pin 25 and the conduit 23 or between the pin 25 and the second opening 22. This will help to ensure that the low pressure region 41 works to retract the pin 25. Rather than air simply flowing in from the second opening 22 and past the outside of the pin 25.

A preferred aspect of using a vacuum cleaner 40 to release the locking device 10 is that it allows for easy retrieval of the first component 20. For example, long rigid extension pieces or wands 40, are common on vacuum cleaners, thereby allowing the first component 20 to be removed even from a high ceiling without the need for a step or ladder. As shown in FIGS. 1A and 1B, the first opening 21 is preferably in the form of a socket adapted for insertion of the end of a vacuum cleaner wand 40 sufficient to support the smoke alarm 20 on the end of the wand.

In an example embodiment, the locking device 10 is arranged so that an entire smoke alarm is released from a bracket on a ceiling, thereby allowing for a battery in the smoke alarm to be changed or the smoke alarm to be cleaned, inspected and/or tested. The retaining bracket 30, meanwhile, would be permanently fixed to the ceiling. Preferably, this would be a very simple item that does not require maintenance.

In another example embodiment, the first component 20 may be a storage device to which clothes or other items can be attached, and the second component 30 may be a bracket. Again, the storage device can be secured to the bracket even in a position that would normally be very difficult to reach, thanks to vacuum cleaner extensions that are commonly available. This allows for items to be stored in positions that would otherwise be very inconvenient, thereby providing a means for utilising extra space in a home or other building.

Smoke alarms are commonly wired to a source of mains power with a battery provided only as backup. In an example embodiment, this connection may be provided by the pin 25 and a contact in the recess 31, or alternatively by some other system of contacts in the smoke alarm and bracket that provide an electrical connection when the smoke alarm is locked in place in the bracket, while not preventing the smoke alarm from being removed.

When the first component 20 is released from the second component 30, it will ideally remain attached to the vacuum cleaner wand 40, thereby allowing the first component 20 to be safely lowered without damage to the first component 20 of the first component 20 falling and injuring a person. The first component 20 can be removed from the end of the vacuum cleaner wand 40 when appropriate by providing sufficient force or by simply turning off the vacuum cleaner.

A seal 26 is provided at the opening 21 on the first component 20 that assists in providing the low pressure region 41. This may include a sealing surface that aids with sealing to a typical vacuum cleaner attachment. It may also include an attachment, such as a cylindrical section, that allows a vacuum cleaner 40 to be connected directly.

Returning the first component 20 to the locked position can be achieved by turning on the vacuum cleaner 40 and attaching the first component 20 to the wand 40. This allows the first component 20 to be safely raised or moved into position, while also holding the pin 25 in the retracted position. Once the first component 20 is in an appropriate position, the vacuum cleaner 40 can be turned off, allowing the pin 25 to move into an extended position and thereby locking device 10 into a locked position to component 30.

Alternatively, the locking device 10 may be arranged so that it can be pushed into place without the need for the low pressure region 41 to retain the pin 25 in the retracted position. In other words, the pin 25 can be pushed into the retracted position, by the second component 30 as the first component 20 is inserted towards the locked position. When the appropriate position is reached the pin 25 will automatically move to the extended position due to gravity or the biasing means, such that the pin 25 is in the recess 31 and, therefore, the locking device 10 is in the locked position.

Another example embodiment includes a smoke alarm with two or more of the locking devices 10. Two locking devices 10 will generally be sufficient, however, three or more may provide a more secure retention of the smoke alarm and provide backup in the event that one or more of the locking devices 10 fail. In such an embodiment with two or more locking devices 10, the locking devices may be completely independent, or alternatively may share certain portions. For example, an embodiment may include a single first opening 21 that is connected by a conduit 23 to two separate second openings 22, where a pin 25 protrudes from each of the second openings 22.

In an alternative embodiment, the first component 20 may only be a protective cover of a smoke alarm and the second component 30 may be a permanently fixed main body of a smoke alarm.

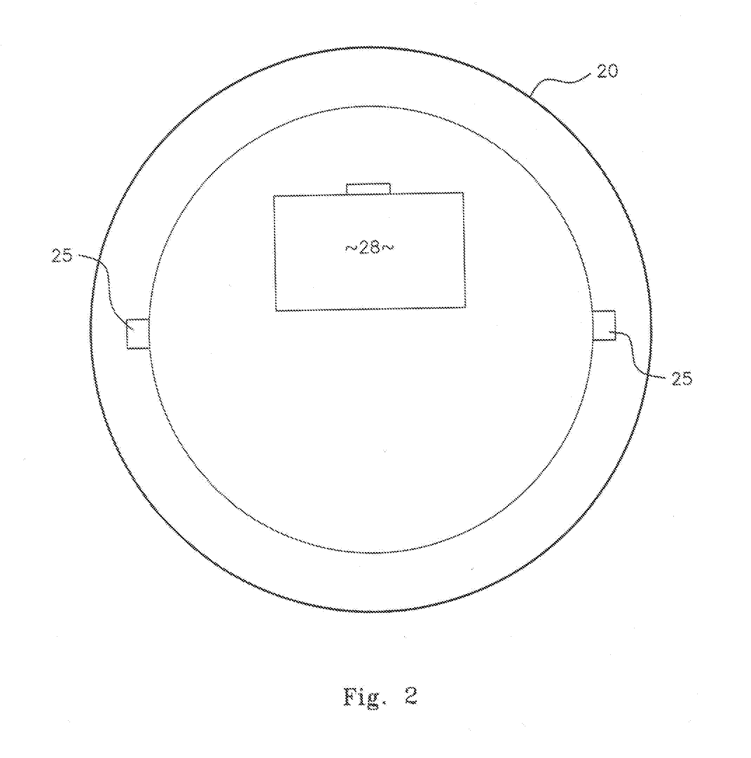

Referring to FIG. 2, an example embodiment is shown of a first component 20 that has been constructed by modifying a prior art smote alarm. Pins 25 can be seen protruding from the sides of the first component 20 and a battery 28 is shown, illustrating that by removing the first component 20 the battery 28 can be easily accessed.

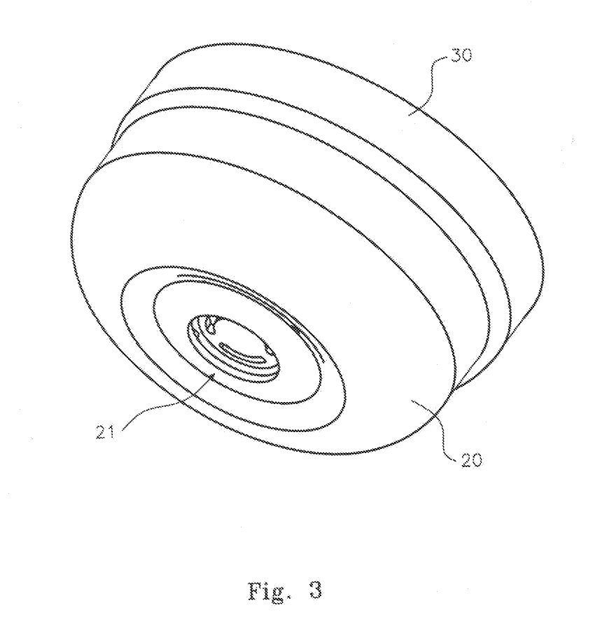

Referring to FIG. 3, an embodiment is shown of a first component 20 in the locked position inside a bracket, or second component 30. FIG. 4 shows a different view of the embodiment of FIG. 3. In FIG. 4, two instances of the first opening 21 can be seen on the outer surface 26 of the first component 20.

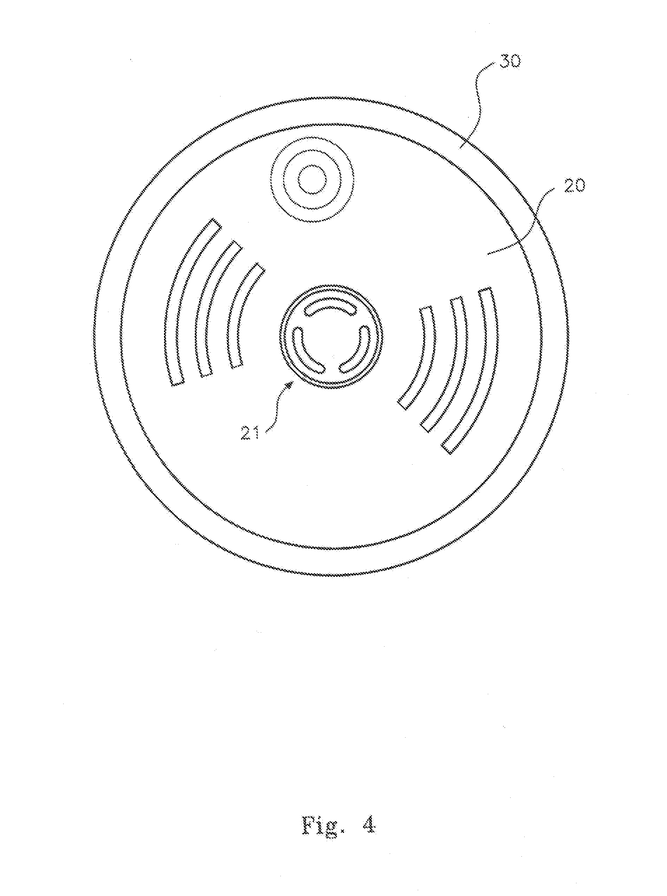

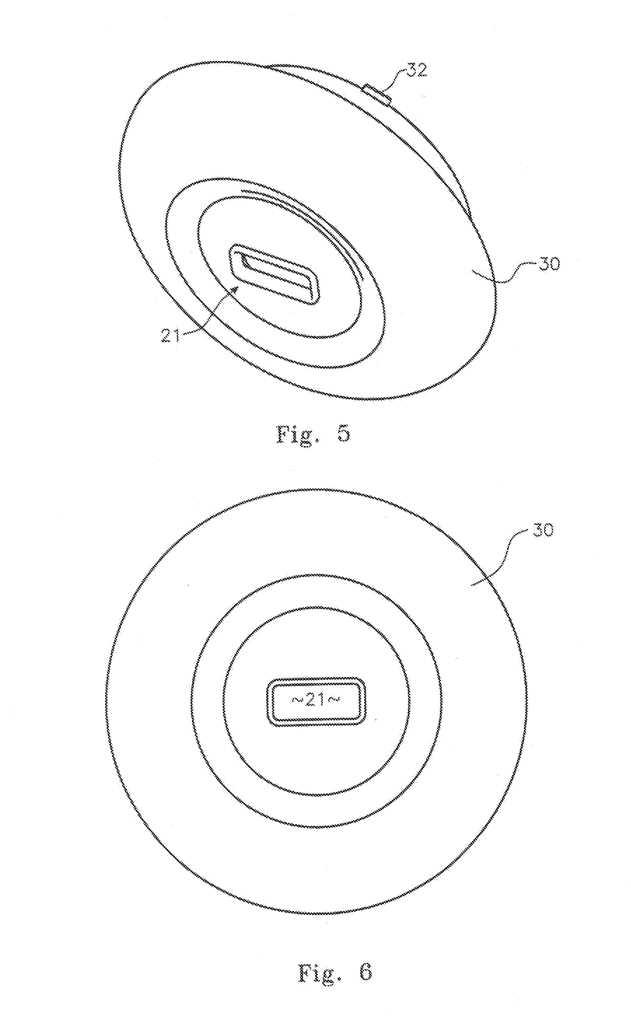

Referring now to FIGS. 5 and 6, in a further preferred embodiment according to the invention, the opening 21 in this instance is of a rectangular cross section. The rectangular section slot of the opening 21 is adapted to receive the rectangular section wand attachment (not shown) commonly provided with vacuum cleaners.

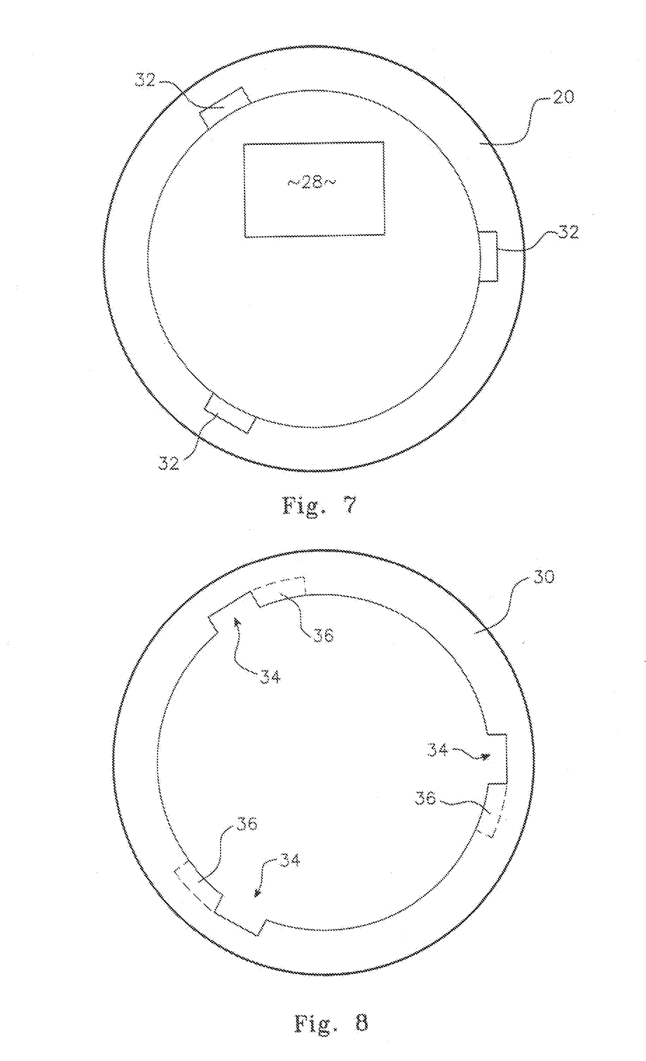

In this embodiment of the invention, the smoke alarm 20 may be retained in a locked position, in bracket 30 by a bayonet type connection, in which the smoke alarm body is provided with at least two, preferably three projections 32 as shown in FIG. 7, for inserted and rotated connection with corresponding openings 34 and ledges 36 in the bracket 30 shown in FIG. 8.

In this arrangement the vacuum cleaner wand and the attachment serve only to allow a user standing on a floor surface below the smoke alarm of this embodiment, to reach and insert the wand attachment, into the opening 21. To release the smoke alarm 30 from the bayonet connection with the bracket 30, the user need only apply sufficient rotation to the wand (and thus its attachment) to bring the projections 32 into alignment with the openings 34 to release and lower the smoke alarm to within reach. In each embodiment of the invention, the hole in the smoke alarm body accesses a socket of sufficient depth to support a smoke alarm on the end of an elongate implement inserted into the socket to safely lower or raise a smoke alarm body by means of the elongate implement.

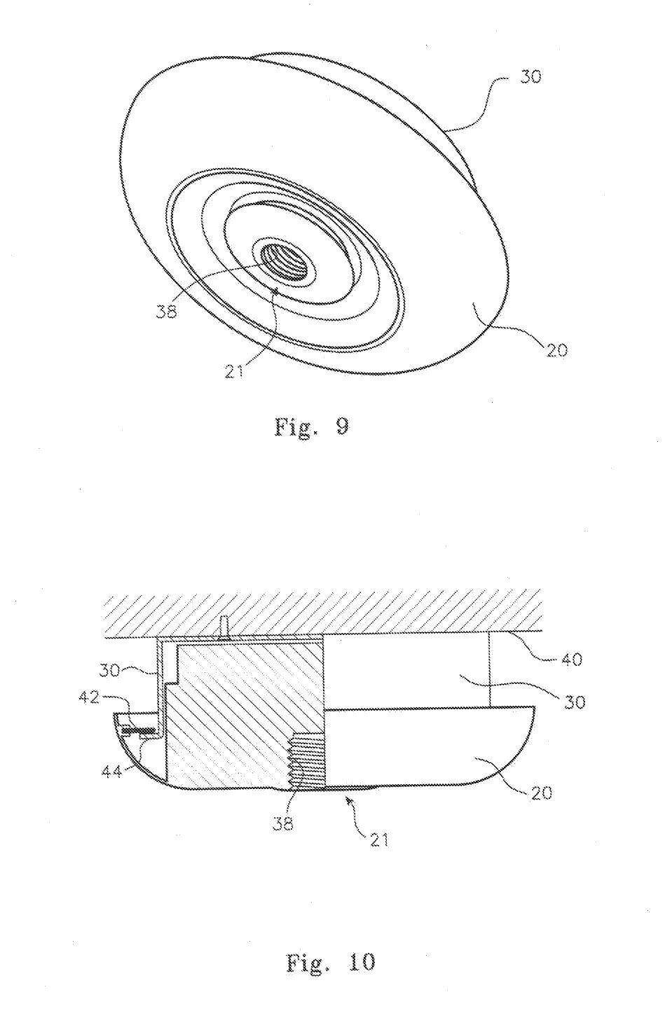

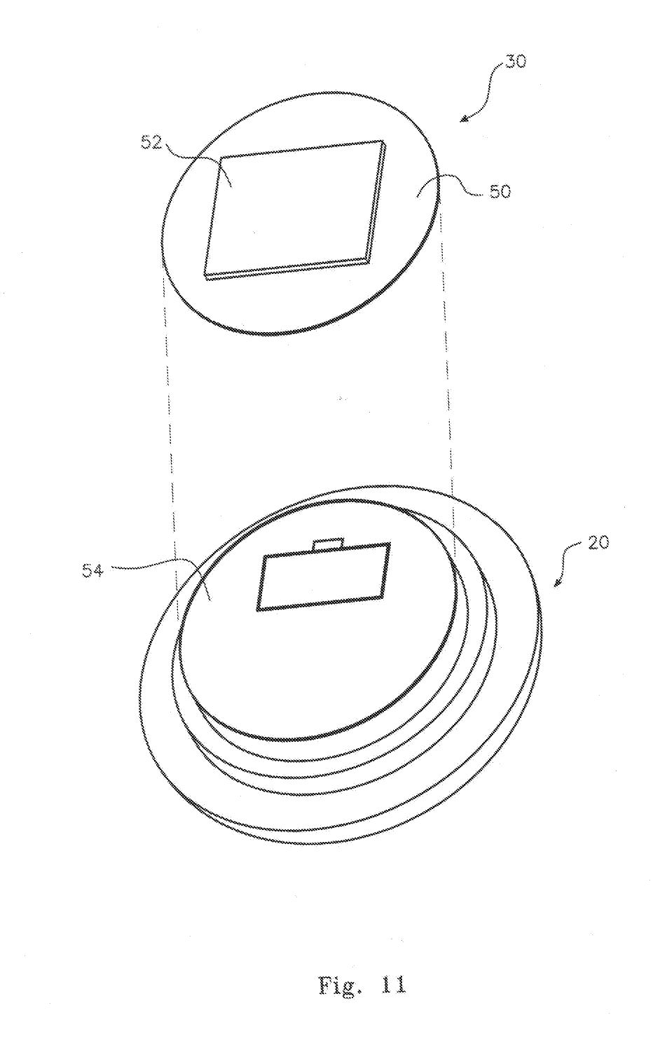

FIGS. 9 and 10 show another preferred embodiment of a smoke alarm release system in which the opening 21 accesses a threaded socket. The thread 38 of the socket conforms to the thread of a threaded stud at the outer end of an elongate implement which is a handle of a household device, such as commonly used on cleaning devices adapted for engagement with interchangeable cleaning heads or other implements. Typical examples are brooms, mops, “turks heads”, window wipers and gardening tools for example.

The threaded socket allows a user standing on a floor surface below a smoke alarm 20, retained in a bracket 30 attached to an over-head surface 40, to screw the threaded end of the elongate implement (not shown) into the socket. In this embodiment, as shown in FIG. 10, the smoke alarm 20 is provided with an annular flexible ring 42 while the bracket 30 is formed with an annular projecting flange 44. Alternatively, the flexible ring could be provided in the bracket and the smoke alarm body formed with a projecting flange.

Flexible ring 42 is of sufficient stiffness to support the weight of smoke alarm 20, but is also sufficiently flexible to allow the smoke alarm to be pulled through the ring 42 by a downward force applied to an elongate implement, either the handle with threaded end screwed to a threaded socket, or a vacuum cleaner wand applying sufficient vacuum force to pull the alarm body free of the flexible ring.

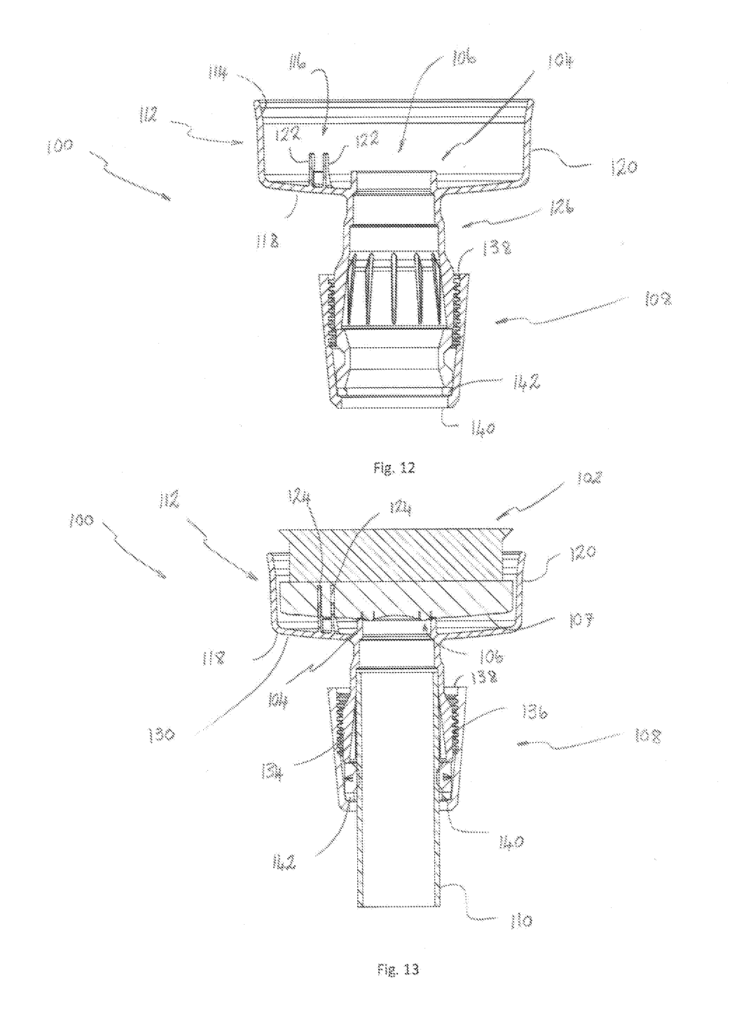

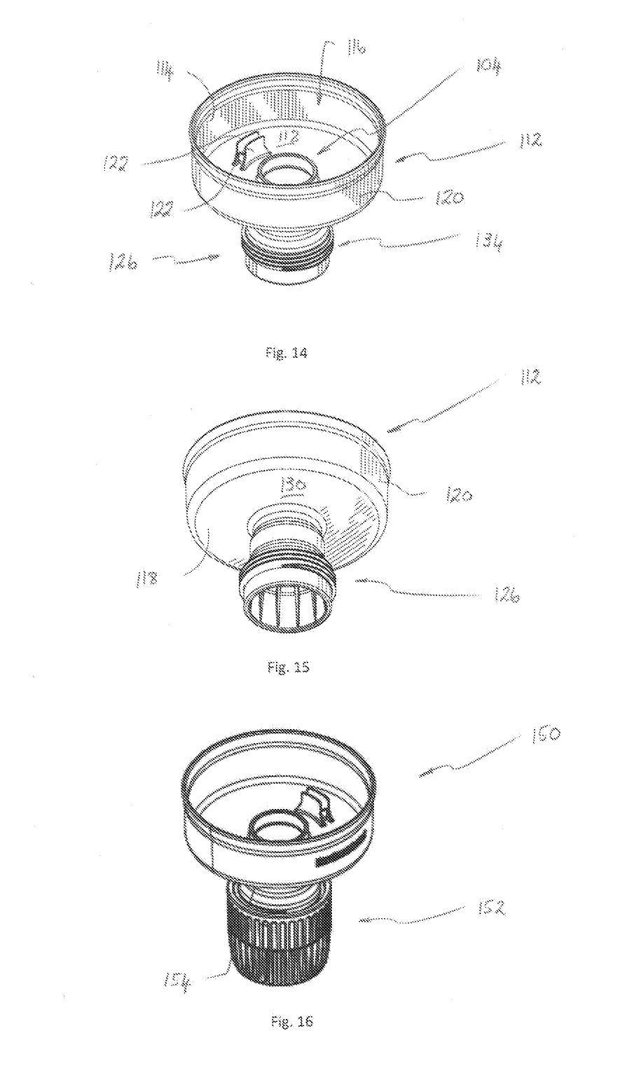

FIGS. 12 and 13 show an adapter 100 for use in mounting and/or dismounting a conventional gaseous substance detector 102 to/from an overhead surface, such as a ceiling. In this embodiment the gaseous substance detector is a smoke alarm. It will of course be appreciated that various different gaseous substance detectors could be mounted/dismounted with the use of the adapter 100. The adapter 100 comprises a detector abutment 104 for operative placement adjacent an outer surface 106 of the detector 102. The detector abutment 104 defines an annular opening 106, also shown in FIG. 14.

The adapter 100 further comprises a coupling 108 operatively associated with the detector abutment 104. The coupling 108 is operatively adapted for releasable attachment to an elongate implement 110 to provide fluid communication between the opening in the detector abutment 104 and the elongate implement 110. In this embodiment the elongate implement 110 is a wand of a non-illustrated vacuum cleaner and the adapter 100 facilitates fluid communication between the vacuum cleaner and the detector 102. In use, the non-illustrated vacuum cleaner will generate a low air pressure force in the vacuum wand 110. When the low air pressure force in the vacuum wand 110 is applied to the detector 102 (via the opening 106 in the adapter 102), the low air pressure force will act to secure the detector 102 to the adapter 100 and, as a result, to the vacuum wand 110.

Typically the detector 102 will have a non-illustrated magnetic plate attached to it with doubled-sided adhesive tape. A corresponding non-illustrated supporting element, which comprises a magnetic plate, will be affixed to an overhead surface with doubled-sided adhesive. The detector 102 is secured to the supporting element magnetic plate on the overhead surface by the magnetic interaction between the detector magnetic plate and the support element magnetic plate.

To attach the detector 102 to the supporting element, the vacuum cleaner is switched on and the detector 102 located proximate the detector abutment 104 of the adapter 100. The detector 102 is then secured to the adapter 100 under the influence of the low air pressure force. The vacuum wand 110 can now be lifted upwards until the detector magnetic plate attaches to the support element magnetic plate. The vacuum cleaner is now switched off so that the low air pressure force is removed and the wand 110 and adapter can be removed from the detector 102, the magnetic interaction between the detector magnetic plate and the support element magnetic plate ensuring the detector remains in position on the overhead surface.

The adapter 100 comprises a detector receptacle 112 having an inner surface 114 defining a hollow compartment 116 to hold the detector 100. The detector receptacle 112 comprises a receptacle base 118 and a peripheral flange 120 outwardly extending from the receptacle base 118 to define the hollow compartment 116. In this embodiment the detector abutment 104 comprises a cylindrical sleeve which extends from the receptacle base 118 into the hollow compartment 116 formed by the detector receptacle 112. As shown the detector 102 is partially enclosed by the detector receptacle 112 and serves to prevent the detector 102 falling and causing injury to a user during mounting or demounting of the detector 102 from an overhead surface.

The detector receptacle 112 includes two vent projections 122, which extend from the receptacle base 118 into the hollow compartment 118. The vent projections 122 are operatively adapted to be located within vent openings 124 of the detector 102. The vent openings 124 are conventional in, for example smoke detectors/alarms, and provide an inlet through which a gaseous substance can pass in order to be detected by the substance detection system of the detector 102. The purpose of the vent projections 122 are to assist in removing the detector 102 from an overhead support surface. By locating the vent projections 122 within the vent opening 124 and by using the vacuum cleaner wand 110 to apply a lateral force to the adapter 100, the vent projections 122 will apply a lateral force to the detector 102 so that it can be slid from the support element magnetic plate.

The embodiment coupling 108 comprises a male coupling member 126 and a corresponding female coupling member 128. The female coupling member 128 is adapted for axial movement relative to the male coupling member 126. The male coupling member outwardly extends for an outer surface 130 of the receptacle base 118. The male coupling member 126 is adapted slidably to receive a portion of the elongate implement 110.

In this embodiment the female coupling member 128 houses a resilient gripping member 132, here a resilient grommet in the form of a rubber cylinder. The coupling 108 is configured such that relative movement between the male coupling member 126 and the female coupling member 128 can apply a compressive force to the gripping member 132 so as to cause deformation of the resilient gripping member 132. Deformation of the gripping member 132 will cause it to grip an outer surface of the wand 110 tightly so as to secure the adapter 100 to the wand 102. By removing the compressive force, the resilient member 132 will be allowed to return to its former dimensions so that the adapter 102 can be removed from the wand 110.

The male coupling member 126 includes a first threaded portion 134 and the female coupling member 128 includes a complemental second threaded portion 136. The female coupling member 128 has a first open end 138 for receiving the male coupling member 126 and a second open end 140 for receiving the wand 110. As shown the female coupling member tapers radially inwards from the first open end 138 to the second open end 140.

The coupling 108 houses an annular pressure ring 142 at the second open end 140. The resilient gripping member 132 is located between the male coupling member 126 and the pressure ring 142. The pressure ring 142 serves to provide for an equal deformation across the gripping member 132.

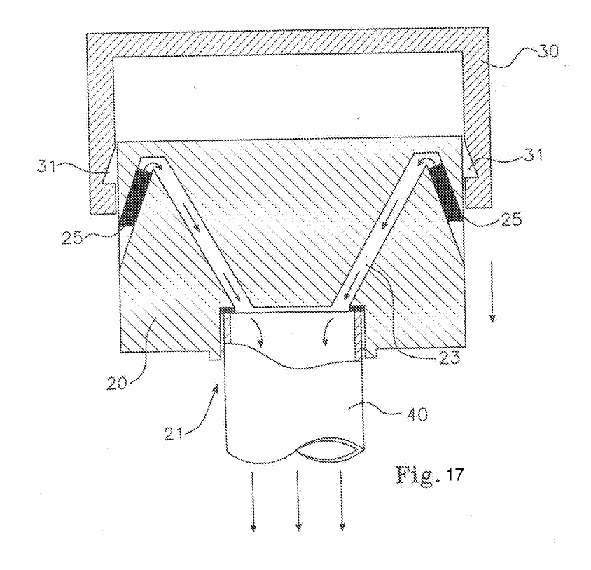

FIG. 16 shows a second embodiment adapter 150 which operates in a manner similar to the first adapter 100. The adapter 150 includes a female coupling member 152 having a knurled outer surface 154.

1. An adapter for use in mounting and/or dismounting a gaseous substance detector from an overhead surface, the adapter comprising:
a detector abutment for operative placement adjacent an outer surface of the detector, the detector abutment defining an opening; and
a coupling operatively associated with the detector abutment, the coupling operatively adapted for releasable attachment to an elongate implement to provide fluid communication between the opening in the detector abutment and the elongate implement,
wherein a low air pressure force in the elongate implement is operatively applied to the detector via the opening to secure the detector to the adapter.

2. An adapter according to claim 1, comprising a detector receptacle operatively associated with the detector abutment, the detector receptacle having an inner surface defining a hollow compartment to hold the detector.

3. An adapter according to claim 2, wherein the detector receptacle comprises a receptacle base and a peripheral flange outwardly extending from the receptacle base to define the hollow compartment.

4. An adapter according to claim 3, wherein the detector abutment extends from the receptacle base into the hollow compartment of the detector receptacle.

5. An adapter according to claim 4, wherein the detector receptacle includes a vent projection extending from the receptacle base into the hollow compartment, the vent projection operatively adapted to be located within a vent opening of the detector.

6. An adapter according to claim 5, wherein the coupling comprises a male coupling member and a corresponding female coupling member adapted for movement relative to the male coupling member.

7. An adapter according to claim 6, wherein the male coupling member outwardly extends for an outer surface of the receptacle base.

8. An adapter according to claim 7, wherein the male coupling member is adapted to receive a portion of the elongate implement.

9. An adapter according to claim 8, wherein the female coupling member houses a resilient gripping member.

10. An adapter according to claim 9, wherein the coupling is configured such that relative movement between the male coupling member and the female coupling member causes deformation of the resilient gripping member, such deformation causing the resilient gripping member to grip an outer surface of the elongate implement.

11. An adapter according to claim 10, wherein the male coupling member includes a first threaded portion and the female coupling member includes a complemental second threaded portion.

12. An adapter according to claim 11, wherein the coupling includes an annular pressure ring.

13. An adapter according to claim 12, wherein the resilient gripping member is located between the male coupling member and the pressure ring.

14. A method of mounting and/or dismounting a gaseous substance detector from an overhead surface, the method comprising the steps of:
providing an adapter according to claim 1;
attaching the coupling of the adapter to an elongate implement to provide fluid communication between the opening in the detector abutment and the elongate implement;
locating the detector abutment of the adapter adjacent an outer surface of the detector; and
applying a low air pressure force to the opening of the adapter via the elongate implement to secure the detector to the adapter.
